(19) United States
(12) Patent Application Publication
(10) Pub. No.: US 2021/0009393 A1
(43) Pub. Date: Jan. 14, 2021

(54) LOAD FEEDBACK ASSEMBLY FOR LIFTING APPARATUS

(71) Applicant: MVP (H.K.) Industries Limited, Hong Kong (CN)

(72) Inventor: Josh Lane, Kansas City, MO (US)

(73) Assignee: MVP (H.K.) Industries Limited, Hong Kong (CN)

(21) Appl. No.: 16/510,544

(22) Filed: Jul. 12, 2019

(51) Int. Cl. B66F 17/00; B66F 5/04; G01G 19/08; G08B 21/18

(52) U.S. Cl. CPC B66F 17/00; G08B 21/182; G01G 19/083; B66F 5/04

(57) ABSTRACT

A load feedback assembly includes a load receiving portion moveably secured within a main body, a sensor device selectively engageable by the load receiving portion, and a biasing device disposed between the load receiving portion and the sensor device. The biasing device has a biasing force that is configured to urge the load receiving portion away from the sensor device, and the biasing force is overcome when a load on the load receiving portion exceeds a predetermined weight threshold.

### BACKGROUND

Mechanical jacks or similar lifting apparatuses are used in applications in which large loads must be raised and lowered in a reliable, efficient, simple and safe fashion. For example, mechanical jacks are often used to raise and lower vehicles and/or towed attachments, including items such as cars, trucks, tractors, trailers, and agricultural implements. A lifting portion of the jack can be moved linearly between a raised or extended position and a lowered or retracted position.

Jacks are usually rated for a maximum lifting capacity (for example, 1.5-3 tons). However, the weight of the object to be lifted is often unknown. A loadcell (such as a compression disk loadcell) or other weighing device may be incorporated into the jack, however, such integration can be complicated and costly. Accordingly, a simple yet reliable load sensor device configured to warn a user if the object to be lifted exceeds a predetermined weight threshold is needed.

### SUMMARY

A load feedback assembly includes a load receiving portion moveably secured within a main body, a sensor device selectively engageable by the load receiving portion, and a biasing device disposed between the load receiving portion and the sensor device. The biasing device has a biasing force that is configured to urge the load receiving portion away from the sensor device, and the biasing force is overcome when a load on the load receiving portion exceeds a predetermined weight threshold.

A lifting apparatus includes a lifting arm configured to lift a load and a load feedback assembly secured to the lifting arm and configured to receive the load. The load feedback assembly includes a load receiving portion moveably secured within a main body, a sensor device selectively engageable by the load receiving portion, and a biasing device disposed between the load receiving portion and the sensor device. The biasing device has a biasing force that is configured to urge the load receiving portion away from the sensor device, and the biasing force is overcome when a load on the load receiving portion exceeds a predetermined weight threshold.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a first isometric view of a lifting apparatus having a load feedback assembly formed in accordance with an exemplary embodiment of the present disclosure;

FIG. 2 is a second isometric view of the lifting apparatus and load feedback assembly of FIG. 1;

FIG. 3 is a cross-sectional view of the lifting apparatus and load feedback assembly of FIG. 2 taken substantially across line 3-3;

FIG. 4 is a top isometric view of the load feedback assembly of FIG. 1;

FIG. 5 is a bottom isometric view of the load feedback assembly of FIG. 1;

FIG. 6 is a top view of the load feedback assembly of FIG. 1;

FIG. 7 is a top exploded view of the load feedback assembly of FIG. 1;

FIG. 8 is a bottom exploded view of the load feedback assembly of FIG. 1;

FIG. 9a is a cross-sectional view of the load feedback assembly of FIG. 6 taken substantially across line 9-9, wherein the load feedback assembly is shown in a first, non-activated position; and

FIG. 9b is a cross-sectional view of the load feedback assembly of FIG. 6 taken substantially across line 9-9, wherein the load feedback assembly is shown in a second, activated position.

### DETAILED DESCRIPTION

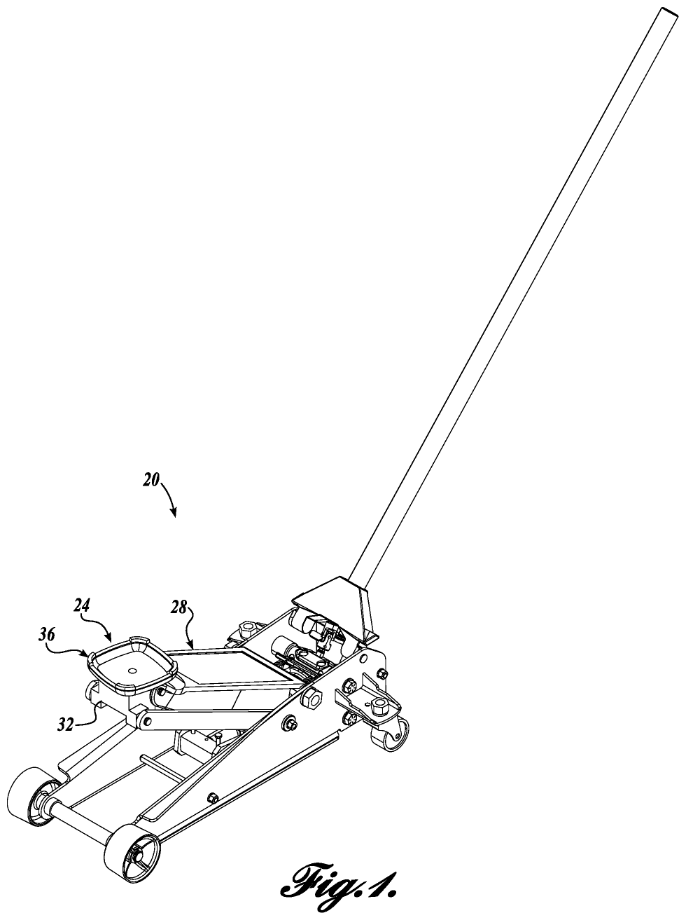

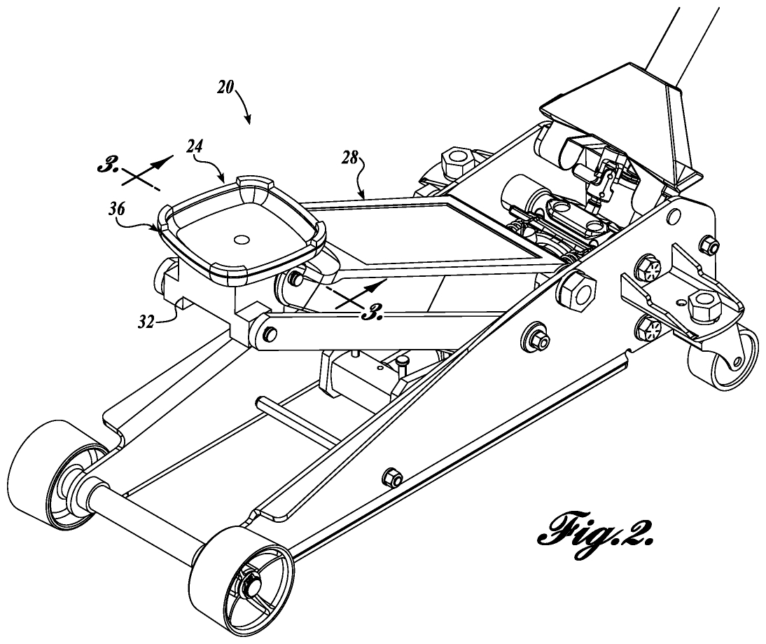

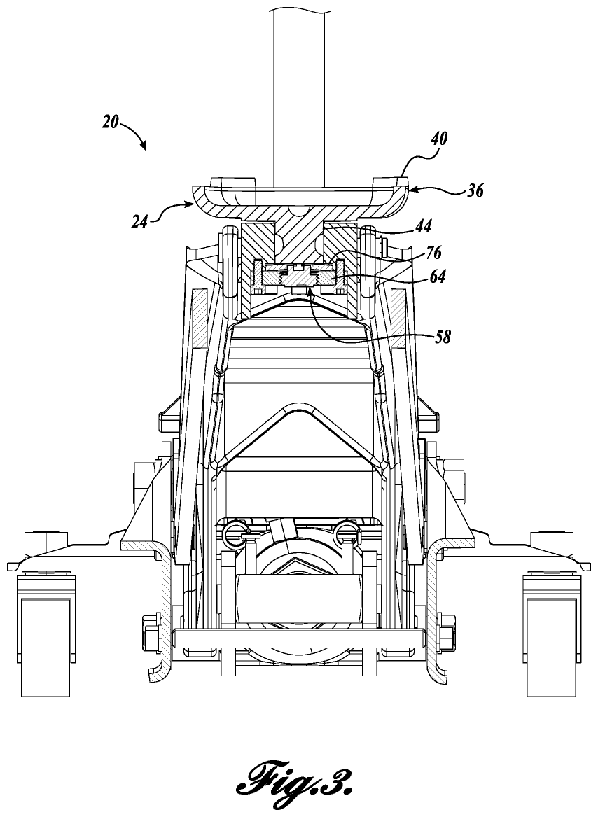

A lifting apparatus 20 having a load feedback assembly 24 formed in accordance with an exemplary embodiment of the present disclosure may best be seen by referring to FIGS. 1-3. In the embodiments shown and described herein, the lifting apparatus 20 is embodied as a mechanical manual hydraulic forklift jack; however, it should be appreciated that the lifting apparatus 20 may instead be other configurations, such as a screw jack, a pneumatic jack, a bottle jack, etc. Moreover, the load feedback assembly 24 may instead be used with any suitable apparatus or assembly configured to receive a load. Accordingly, the descriptions and illustrations provided herein should not be seen as limiting the scope of the claimed subject matter.

The load feedback assembly 24 in secured on or otherwise defines a portion of a lifting arm 28 of the lifting apparatus 20 and bears the weight of the load to be lifted. In that regard, the load feedback assembly 24 is mounted on an upper distal end of the lifting arm 28 such that it can engage and support a bottom surface of the load.

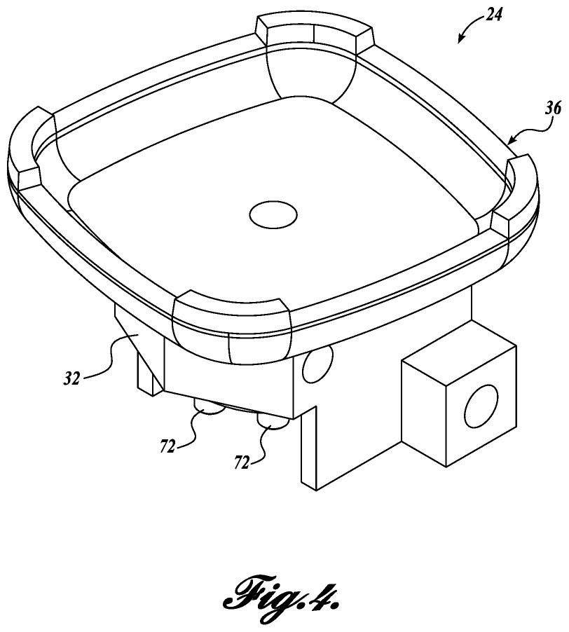

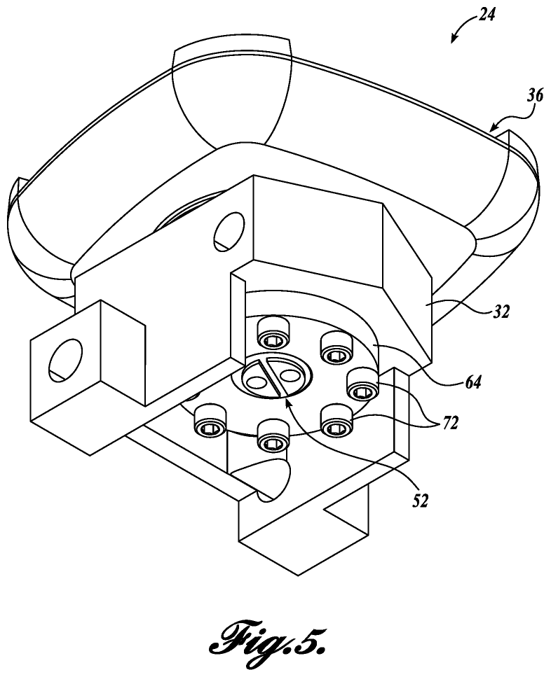

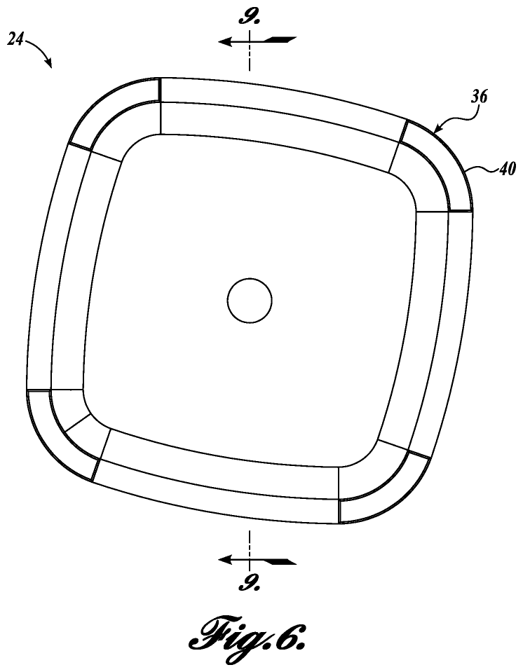

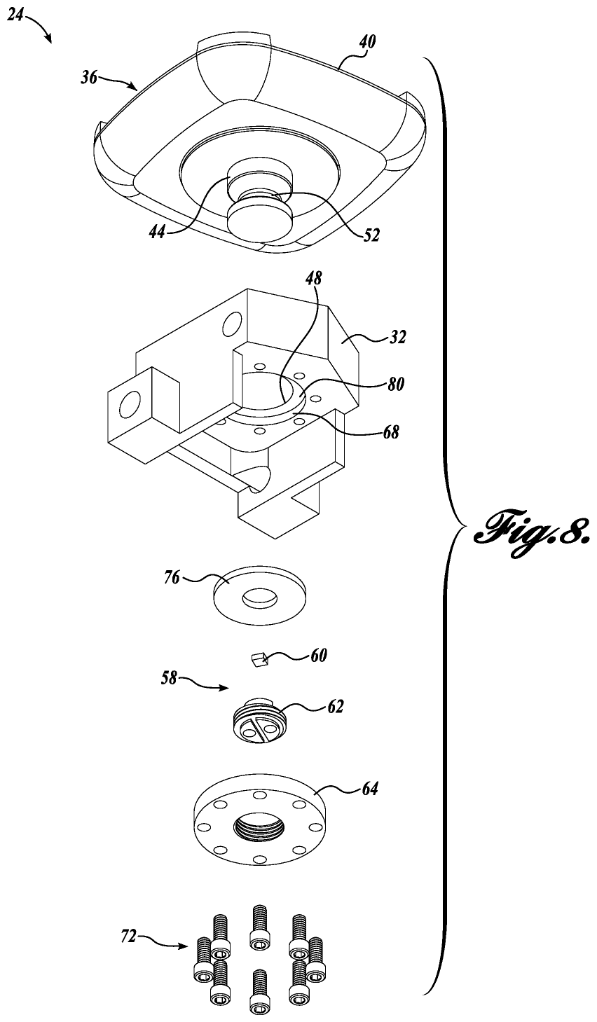

Referring to FIGS. 4-9, a first exemplary embodiment of the load feedback assembly 24 configured for use with the lifting apparatus 20 or any other suitable lifting apparatus or jack will now be described in detail. The load feedback assembly 24 is generally configured to support and sense a load as it is lifted by the lifting apparatus 20 and configured to provide feedback if the sensed load exceeds a predetermined weight threshold.

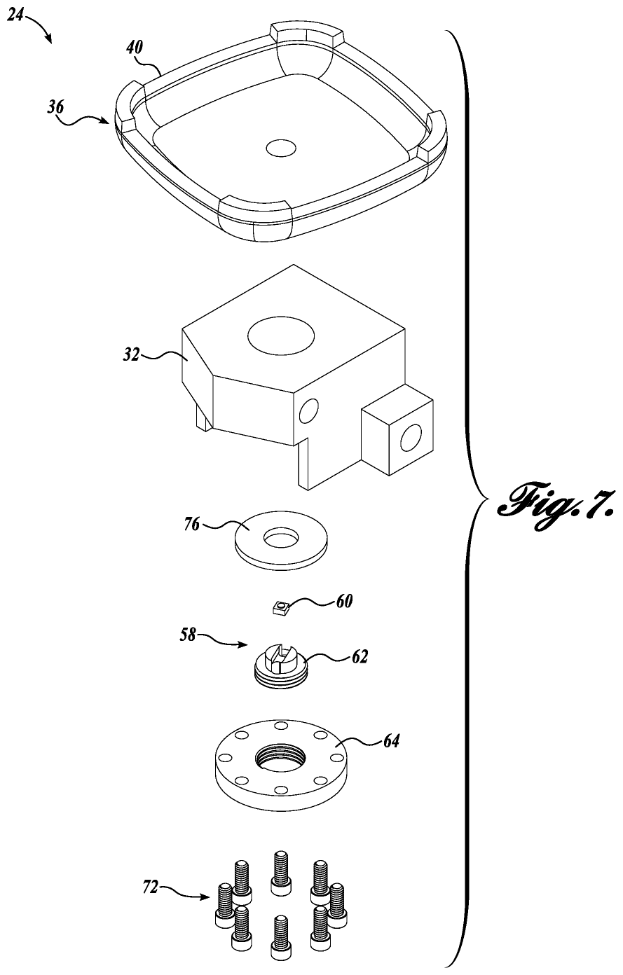

As can best be seen by referring to FIGS. 7-9, the load feedback assembly 24 includes a main load sensor body 30 configured to be secured to the distal end of the lifting arm 28, and a load receiving portion or saddle 36 movably secured to the main load sensor body 32. The main load sensor body 32 is any suitable shape, size, and configuration to suitably mount the load feedback assembly 24 to the lifting apparatus 20 and to bear the weight of the load as it is sensed by the load feedback assembly 24.

In the depicted embodiment, the main load sensor body 30 is generally rectangular shaped or another suitable shape for being secured to and integrated with the lifting apparatus 20. A suitable attachment structure may be used to secure the main load sensor body 30 to the lifting apparatus 20. In the depicted embodiment, the main load sensor body 30 includes a plurality of attachment openings (such as bolt holes) configured to receive a pin, fastener, etc. (such as a bolt) for securing the main load sensor body 30 to the distal end of the lifting arm 28. In that regard, the main load sensor body 30 may be moveably or pivotally secured to the lifting arm 28 such that it can remain in a substantially horizontal orientation when the lifting arm 28 is raised or lowered.

As noted above, the load receiving saddle 36 is movably secured to the main load sensor body 32 such that it is configured to support and sense a load as it is lifted by the lifting apparatus 20. In that regard, the load receiving saddle 36 includes an upper load-receiving portion 40 that is positioned on top of the main load sensor body 30 such that it is configured to receive the load. The upper load-receiving portion 40 may be any suitable shape, size, and configuration for the intended application. For instance, in the depicted embodiment, the upper load-receiving portion 40 is a saddle configuration that is generally a soft square shape having upwardly turned edges. One or more protrusions may extend upwardly from the upper edge of the upper load-receiving portion 40 for engaging with or otherwise gripping a portion of the load to be lifted.

The load receiving saddle 36 also includes a lower stem portion 44 extending downwardly from a bottom surface of the upper load-receiving portion 40 for mating with the main load sensor body 30. The lower stem portion 44 is sized and shaped to be moveably received within a bore 48 of the main load sensor body 30. In the depicted embodiment, the lower stem portion 44 is substantially cylindrically shaped to fit within the correspondingly shaped bore 48. The outer diameter of the lower stem portion 44 may be slightly smaller than the inner diameter of the bore 48 to allow the lower stem portion 44 to slide axially within the bore 48 but to maintain substantial axial alignment therebetween.

The lower stem portion 44 may be axially retained within the main load sensor body 30 in any suitable manner. For instance, a ball detent mechanism or the like may be used to axially retain the lower stem portion 44 within the main load sensor body 32. In the depicted embodiment, the lower stem portion 44 includes an annular detent 52 extending around its circumference that receives a ball, protrusion, seal, etc. (shown as a ball 56) to axially retain the lower stem portion 44 within the main load sensor body 32. The ball 56, when received within the annular detent 53, axially retains the lower stem portion 44 within the main load sensor body 32. However, at the same time, the stem portion 44 can move axially within the main load sensor body 32 in response to the weight of a load.

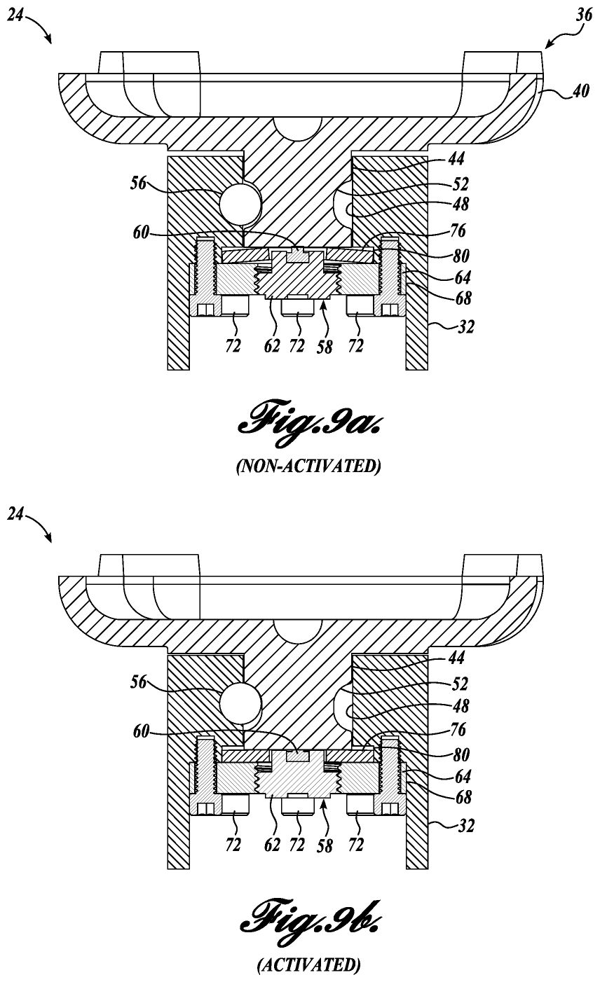

The lower stem portion 44 is engageable with sensor components of the load feedback assembly 24 when it is moved between raised and lowered axial positions relative to the main load sensor body 32. Referring to FIGS. 7, 8, and 9a-9b, the load feedback assembly 24 includes a sensor device, such as a mechanical button assembly 58 disposed within the interior of the main load sensor body 32 beneath the biasing device 76. The button assembly 58 is positioned to be selectively engaged by or otherwise activated by the lower stem portion 44 of the saddle 36 when the lower stem portion 44 is moved into a lowered axial position, as shown in FIG. 9b. It should be appreciated that the sensor device may instead be any other suitable sensor or assembly, such as a switch, a proximity sensor, etc.

In the depicted embodiment, the button assembly 58 is defined by a button 60 moveably retained within a carriage 62, wherein the carriage 62 is secured within the main load sensor body 32. In the depicted exemplary embodiment, the carriage 62 is adjustably secured within a lower cap 64 that mates with and is secured within a bottom open end of the main load sensor body 32. In that regard, the carriage 62 may be substantially cylindrically shaped and received within a correspondingly shaped opening in the lower cap 64. The carriage 62 may be adjustably secured within the lower cap 64 in any suitable manner. For instance, the carriage 62 may include threads on its exterior annular surface that are mateable with threads on the interior annular surface of a central opening in the lower cap 64 (threads not labeled). In this manner, the carriage 62 may be adjusted in its axial position within the main load sensor body 32 simply by threading or unthreading the carriage 62 within the lower cap 64.

The carriage 62 is adjusted in its axial position within the lower cap 64 to correspondingly change the axial position at which the button 60 is engaged by the lower stem portion 44. The axial position of the button 60 may be adjusted, for instance, to change the weight threshold of the load feedback assembly 24. More specifically, the button 60 may be moved axially toward the lower stem portion 44 of the saddle 36 to allow the lower stem portion 44 to engage the button 60 with a lighter load, or the button 60 may be moved axially away from the lower stem portion 44 of the saddle 36 to such that a heavier load is needed to move the lower stem portion 44 into engagement with the button 60. It should be appreciated that the button assembly 58 may be adjustably secured within the main load sensor body 32 in any other suitable manner.

In the depicted embodiment, the lower cap 64 mates with and is secured within a first counter bore 68 of the main load sensor body 32. The first counter bore 68 is defined in a bottom open end of the main load sensor body 32 and is in substantial coaxial alignment with the main bore 48. In that regard, the lower cap 64 is annular in shape and has an outer diameter that is substantially similar to the inner diameter of the first counter bore 68. The lower cap 64 is (optionally releasably) secured within the first counter bore 68 in any suitable manner, such as with a plurality of fasteners 72 (e.g., bolts) extending through corresponding openings (not labeled) in the lower cap 64 and the main load sensor body 32. In an alternative embodiment, the lower cap 64 maybe received within a transverse slot in the main load sensor body 32 such that fewer or no fasteners are needed.

As can be appreciated from the foregoing, the lower cap 64 is configured to axially position the button assembly 58 within the main load sensor body 32 such that the button 60 is selectively engageable by the lower stem portion 44 when it is moved into the lowered axial position (as shown in FIG. 9a). The lower cap 64 is also configured to receive the load from the saddle 36 when the lower stem portion 44 is moved into the lowered axial position. In that regard, the lower cap 64 is made from a suitable material and has a suitable thickness to withstand the load from the saddle 36. Moreover, the fasteners 72 are of a suitable quantity and strength to withstand the load from the saddle 36.

Referring to FIGS. 9a and 9b, the load feedback assembly 24 is shown in a first, non-activated position and a second, activated position, respectively. In the first, non-activated position, as shown in FIG. 9a, the lower stem portion 44 of the load-receiving saddle 36 is in a first, raised axial position relative to the main load sensor body 32. A biasing device 76 disposed within the main load sensor body 32 urges the lower stem portion 44 of the load-receiving saddle 36 into the first, raised axial position. When a load is placed on the load-receiving saddle 36 and the force of the biasing device 76 is overcome, the lower stem portion 44 of the load-receiving saddle 36 moves into a second, lowered axial position relative to the main load sensor body 32, as shown in FIG. 9b.

As noted above, the button 60 is engaged by or otherwise activated by the lower stem portion 44 of the saddle 36 when the lower stem portion 44 is moved into a lowered axial position, i.e, when the weight of the load overcomes the force of the biasing device 76. In that regard, the predetermined weight threshold is defined in part by the biasing device 76. In the depicted embodiment, the biasing device 76 is located between a bottom surface of the lower stem portion 44 and an upper surface of the lower cap 64. The biasing device 76 is configured to urge the lower stem portion 44, and therefore the saddle 36 into the first, raised (non-activated) position, as shown in FIG. 9a. When the load on the saddle 36 overcomes the force of the biasing device 76, the lower stem portion 44 and saddle 36 move downwardly into the second, lowered (activated) position, as shown in FIG. 9b.

The biasing device 76 may be any suitable configuration for allowing the lower stem portion 44 and saddle 36 to move between at least the raised and lowered positions depending on the weight of the load. In the depicted embodiment, the biasing device 76 is a disc spring (also known as a “Belleville washer”) defined by a convex disc supported at the outer periphery by a first force (from the lower cap 64) and an opposing load force on the center of the disc (from the lower stem portion 44). The disc spring is received within a second counter bore 80 of the main load sensor body 32 located axially between the main bore 48 and the first counter bore 68 and is in substantial coaxial alignment therewith.

The disc spring is configured to achieve a desired load and travel of the biasing device 76. In that regard, the biasing device 76 may include more than one disc spring stacked in parallel or in series to accommodate a different load or travel distance. For instance, a plurality of disc springs may be stacked in parallel to increase the load capacity of the biasing device 76 without affecting the travel distance. In the alternative, a plurality of disc springs may be stacked in series to achieve a greater travel distance without affecting the load capacity. As yet another alternative, a plurality of disc springs may be staked in series and in parallel in a combination arrangement to adjust the load capacity and travel distance of the biasing device 76. It should be appreciated that the biasing device 76 may instead be configured in another suitable manner.

The disc spring of the biasing device 76 is deflected in whole or in part to allow the lower stem portion 44 of the saddle 36 to move into the lowered axial position and activate the button 60. In that regard, the predetermined weight threshold is also defined in part by the axial position of the button assembly 58. As noted above, the axial position of the button assembly 58 may be adjusted by rotating the carriage 62 clockwise or counterclockwise within the lower cap 64 to raise or lower its threaded axial position therein. For instance, if the carriage 62 is axially raised within the lower cap 64, the button 60 will be activated with less travel or deflection of the biasing device 76 than it would with the carriage 62 in a lowermost axial position within the lower cap 64. In the former configuration, a first load is required to compress the biasing device 76 and activate the button 60, and in the latter configuration, a second load greater than the first load is required to compress the biasing device 76 and activate the button 60.

It should be appreciated that the biasing device 76 and/or the axial position of the button assembly 58 may be reconfigured as necessary to adjust the predetermined weight threshold of the load feedback assembly 24. Moreover, with the sensor components of the load feedback assembly 24 being removably secured within the main load sensor body 32, the various components may be replaced as needed.

The button assembly 58 is configured to output a warning, signal, etc., to indicate that the predetermined weight threshold of the load feedback assembly 24 has been met or exceeded. For instance, in one embodiment, the button assembly 58 may be configured to output an audio warning, such as a buzzer, when the predetermined weight threshold has been met. In the alternative or in addition thereto, the button assembly 58 may be configured to output a visual warning, such as a light, when the predetermined weight threshold has been met. In that regard, the button assembly 58 may be in wired or wireless communication with a buzzer and/or light assembly or other suitable warning assembly on the apparatus and/or the load feedback assembly 24.

In the alternative or in addition thereto, the button assembly 58 may be in wired or wired communication with a processing device, such as a computer, smart phone, etc., that is configured to receive and process one or more signals from the button assembly 58. For instance, the processing device may, in response to one or more signals from the button assembly 58, send instructions to a controller of the lifting apparatus 20, deactivating the lifting apparatus 20 if the predetermined weight threshold has been met. In another embodiment, the processing device may, in response to one or more signals from the button assembly 58, send instructions to a controller of a smart phone, tablet, etc., to output an audio and/or visual warning signal.

It should be appreciated from the foregoing that the load feedback assembly 24 is a simple and reliable assembly for warning a user that the load being lifted by the lifting apparatus exceeds a predetermined (maximum) weight threshold. Furthermore, the load feedback assembly 24 may be easily configured for a variety of weight thresholds in a simple and effective manner.

The detailed description set forth above in connection with the appended drawings is intended as a description of exemplary embodiments of the disclosed subject matter and is not intended to represent the only embodiments. The exemplary embodiments described in this disclosure are provided merely as examples or illustrations of a load feedback assembly, and should not be construed as preferred or advantageous over other embodiments. The illustrative examples provided herein are not intended to be exhaustive or to limit the disclosure to the precise forms disclosed. Similarly, any features and/or process steps described herein may be interchangeable with other features and/or process steps, or combinations of features and/or process steps, in order to achieve the same or substantially similar result.

In the foregoing description, numerous specific details are set forth in order to provide a thorough understanding of the exemplary embodiment of the present disclosure. It will be apparent to one skilled in the art, however, that many embodiments of the present disclosure may be practiced without some or all of the specific details. In some instances, well-known features, subassemblies, and/or process steps have not been described in detail in order not to unnecessarily obscure various aspects of the present disclosure. Further, it will be appreciated that embodiments of the present disclosure may employ any combination of features described herein. For instance, any feature or configuration described above with respect to the core may be adapted for use with the cover, and vice versa.

Although certain descriptive terms are used to illustrate or describe certain aspects or benefits of the present invention, they should not be seen as limiting. For instance, although the load feedback assembly is shown and described for use with a lifting apparatus, it should be appreciated that the load feedback assembly described and illustration herein may also be used for other uses not mentioned.

The present disclosure also includes references to directions, such as “vertical”, “horizontal,” “proximal,” “distal,” “upper,” “lower,” “raised”, “lowered”, “upward,” “downward,” “top,” “bottom,” “first,” “second,” etc. These references and other similar references in the present disclosure are only to assist in helping describe and understand the exemplary embodiments and are not intended to limit the claimed subject matter to these directions.

The present disclosure may also reference quantities and numbers. Unless specifically stated, such quantities and numbers are not to be considered restrictive, but exemplary of the possible quantities or numbers associated with the present disclosure. Also in this regard, the present disclosure may use the term “plurality” to reference a quantity or number. In this regard, the term “plurality” is meant to be any number that is more than one, for example, two, three, four, five, etc. The terms “substantially,” “about,” “approximately,” etc., mean plus or minus 5% of the stated value.

While illustrative embodiments have been illustrated and described, it will be appreciated that various changes can be made therein without departing from the spirit and scope of the invention.

1. A load feedback assembly, comprising:
a load receiving portion moveably secured within a main body;
a sensor device selectively engageable by the load receiving portion;
a biasing device disposed between the load receiving portion and the sensor device, the biasing device having a biasing force that is configured to urge the load receiving portion away from the sensor device, wherein the biasing force is overcome when a load on the load receiving portion exceeds a predetermined weight threshold.

2. The assembly of claim 1, wherein the load receiving portion is moveable between a non-activated position, wherein the load receiving portion is spaced from the sensor device, and an activated position, wherein the load receiving portion engages the sensor device.

3. The assembly of claim 1, wherein the load receiving portion moves into the activated position when a load on the load receiving portion exceeds a predetermined weight threshold.

4. The assembly of claim 1, wherein the sensor device is a button assembly.

5. The assembly of claim 4, wherein the button assembly includes an activation button secured within a carriage.

6. The assembly of claim 5, wherein the carriage is adjustable in axial position relative to the main body.

7. The assembly of claim 5, wherein the carriage is adjustably secured within a lower cap secured to a bottom portion of the main body.

8. The assembly of claim 7, wherein the lower cap includes a central opening having threads that are mateable with threads on an external surface of the carriage.

9. The assembly of claim 1, wherein the sensor device is adjustable in its axial position relative to the main body.

10. The assembly of claim 9, wherein the sensor device is removably secured within the main body.

11. The assembly of claim 1, wherein the sensor device is configured to output at least one of a visual and audio warning when the load on the load receiving portion exceeds a predetermined weight threshold.

12. The assembly of claim 1, wherein the biasing device is a disc spring.

13. A lifting apparatus, comprising:
a lifting arm configured to lift a load;
a load feedback assembly secured to the lifting arm and configured to receive the load, the load feedback assembly comprising:
a load receiving portion moveably secured within a main body;
a sensor device selectively engageable by the load receiving portion;
a biasing device disposed between the load receiving portion and the sensor device, the biasing device having a biasing force that is configured to urge the load receiving portion away from the sensor device, wherein the biasing force is overcome when the load exceeds a predetermined weight threshold.

14. The apparatus of claim 13, wherein the load receiving portion is moveable between a non-activated position, wherein the load receiving portion is spaced from the sensor device, and an activated position, wherein the load receiving portion engages the sensor device.

15. The apparatus of claim 13, wherein the load receiving portion moves into the activated position when a load on the load receiving portion exceeds a predetermined weight threshold.

16. The apparatus of claim 13, wherein the sensor device is a button assembly.

17. The apparatus of claim 13, wherein the sensor device is adjustable in its axial position relative to the main body.

18. The apparatus of claim 17, wherein the sensor device is removably secured within the main body.

19. The apparatus of claim 13, wherein the sensor device is configured to output at least one of a visual and audio warning when the load on the load receiving portion exceeds a predetermined weight threshold.

20. The apparatus of claim 13, wherein the biasing device is a disc spring.
